(19) United States
(12) Patent Application Publication
(10) Pub. No.: US 2026/0109484 A1
(43) Pub. Date: Apr. 23, 2026

(54) SEQUENTIAL CONTROL OF ELECTROMAGNETS FOR CUBESAT DOCKING ATTITUDE ALIGNMENT

(71) Applicant: Arizona Board of Regents on Behalf of the University of Arizona, Tucson, AZ (US)

(72) Inventors: Jekan Thangavelautham, Tucson, AZ (US); Virupakshan Vilvanathan, Tucson, AZ (US); Athip Thirupathi Raj, Tucson, AZ (US); Leonard Vance, Tucson, AZ (US); Eniko Enikov, Tucson, AZ (US)

(21) Appl. No.: 19/160,273

(22) PCT Filed: Feb. 27, 2024
(86) PCT No.: PCT/US2024/017398

§ 371 Date: Aug. 27, 2025

Related U.S. Application Data
(60) Provisional application No. 63/448,523, filed on Feb. 27, 2023.

(51) Int. Cl. B64G 1/24; B64G 1/22; B64G 1/36; B64G 1/40; B64G 1/64; B64G 1/66; G05D 1/247; G05D 1/49; G05D 1/661; G05D 109/40

(52) U.S. Cl. CPC B64G 1/245; B64G 1/2227; B64G 1/36; B64G 1/417; B64G 1/6464; B64G 1/66; G05D 1/247; G05D 1/49; G05D 1/663; G05D 2109/40

(57) ABSTRACT

The present disclosure provides a system for autonomously docking a spacecraft, the system comprising: one or more electromagnets; one or more sensors; and a controller. The controller configured to: identify a target; cause movement of the spacecraft closer to the target; determine a change in an orientation of the one or more electromagnets and the mating adapter on the target; and adjust a current in the one or more electromagnets to produce a torque, wherein the torque causes the spacecraft to align with the target.

### CROSS-REFERENCE TO RELATED APPLICATIONS

The present application claims the benefit of the filing date of U.S. Provisional Application Ser. No. 63/448,523, filed Feb. 27, 2023, the entire teachings of which application is hereby incorporated herein by reference.

### STATEMENT REGARDING FEDERALLY SPONSORED RESEARCH OR DEVELOPMENT

This invention was made with government support under 80NSSC19M0197 awarded by the National Aeronautics and Space Administration. The government has certain rights in the invention.

### TECHNICAL FIELD

The present application relates generally to autonomous spacecraft docking and, more particularly, to a sequential control of electromagnets for CubeSat docking attitude alignment.

### BACKGROUND

Autonomous docking is an essential component of spacecraft innovation. It allows spacecraft to link together, allowing for in-space assembly (constructing larger, more sophisticated space structures using building pieces) and on-orbit servicing (transfer of goods and services in space). Non-contact docking is a concept in which two or more spaceships are secured together but do not make physical touch. This makes it safer to attach to another spacecraft because if there are any faults during the rendezvous and proximity operations phase, the chances of collision and subsequent failure are less. As a result, there are fewer chances of contact and leakage problems.

A CubeSat is a class of miniaturized satellite based around a form factor consisting of 10 centimeter (cm) cubes. CubeSats have a mass of no more than 2 kilograms (kg) per unit, and often use commercial off-the-shelf components for their electronics and structure. For bigger “mother” spacecraft, smaller non-contact docking spacecraft can be utilized for formation flying, surveillance, security, and defect detection. One of the safest approaches to this problem is electromagnetic levitation. A magnetic field will keep the CubeSat in place while allowing it to “hover” around the mothership.

Described herein is a system to enable a soft rotational lock between the two spacecraft. Active illumination signals such as flashing light-emitting diodes (LEDs) and photodetectors might be used to identify the docking spacecraft. The docking spacecraft will approach each other and align such that both magnets are in close proximity. Electromagnets are employed for alignment and non-contact docking once the two spacecraft are near enough to one another. A rotational lock between the two spacecraft is accomplished by an algorithm that turns on a ring of electromagnets sequentially in the two spacecraft, causing a differential in attractive forces to provide a roll and then an orientation lock. This method is contrasted to other methods, such as incorporating ratiometric sensors, which raise the voltage in the electromagnet as the magnetic field rises, with negative feedback to assist it in stabilizing. In addition, the system will include concentric anti-polar magnets that resist and attract each other to maintain a steady posture.

### BRIEF DESCRIPTION OF THE DRAWINGS

Reference should be made to the following detailed description which should be read in conjunction with the following figures, wherein like numerals represent like parts.

FIG. 1 is an example of a deployed system in operation, consistent with the present disclosure.

FIG. 2 is an example of a mission docking system;

FIG. 3 is an example of satellites that use magnetic force to hold the docking spacecraft together;

FIG. 4 is an example of a probe and cone docking system;

FIG. 5 is an example of a dynamic model of an electromagnetic system, consistent with the present disclosure;

FIG. 6 is an example of system parameters for the example electromagnetic system of FIG. 5;

FIG. 7 is an example block diagram of a feedback linearization model, consistent with the present disclosure;

FIG. 8 is an example functional block diagram for a non-contact docking CubeSat, consistent with the present disclosure;

FIG. 9 is an example of a concept of operation for a technology demonstrator mission, consistent with the present disclosure; and

FIG. 10 is an example of a step response of a second-order system, consistent with the present disclosure.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

Space was once a new frontier for exploration. Since then, space technology has come a long way. Autonomous docking is an important technology that facilitates in-space assembly (the construction of larger, more sophisticated space structures using building pieces) and on-orbit servicing (transfer of goods and services in space). Non-contact docking is a novel concept involving two or more spacecraft attempting to achieve a stable dock with each other without coming in physical contact. This kind of docking allows for more freedom of error since the spacecraft will attempt to dock with the mothership without contact, therefore reducing the chance of physical failure due to collision or touch. As a result, the chances of leakage problems is also reduced. For larger “mother” spacecraft, smaller non-contact docking spacecraft can be utilized for formation flying, surveillance, security, and fault detection.

Disclosed herein is a system to achieve non-contact docking in space between two small satellites, by having two spacecrafts dock with each other using onboard systems with less usage of active thrusters and fuel. Active lighting cues such as flashing LEDs and photodetectors may be used to identify the docking ship. Once the spacecraft has been recognized, they may approach each other and align so that both electromagnetic systems are in close proximity for active attitude adjustment. Disclosed herein is an electromagnetic system to achieve attitude adjustment and reduce torque as the two spacecraft approach each other and are close enough.

One of the safest approaches to this problem is using an inflatable device to reduce the incoming velocity for the satellite to docking speeds so that the electromagnetic system can achieve soft docking. A magnetic field may help soft dock the CubeSat while allowing it to levitate around the mother spacecraft while locked in orientation with minimal movement. This can be accomplished by incorporating ratiometric sensors, which will increase the voltage in the electromagnet as the magnetic field increases, with negative feedback to assist it to stabilize. To maintain a steady posture, the device may include concentric anti-polar magnets that attract each other.

Docking systems that are currently used in the international space station and other ventures can be categorized into thruster-based docking, tether-based docking, and magnet-based docking. These docking systems are robust and have been tested in commercial applications, however, each has its own advantages and disadvantages. The disadvantages start outweighing the advantages when attempting to shrink the system for small satellite applications. These include problems like increased proportion of fuel consumption as the size of the docking spacecrafts are greatly reduced in small satellite applications.

Thruster-based docking systems are the most common form of docking and have a historical track record. Thrusters provide the most maneuverability and are thus reliable; however, the minimum impulse bit (MIB) of the thrusters affects the resolution of the maneuver and drives consumption up for precise motion like docking. This dictates the minimum impact velocity as well. There also exists the risk of thruster plume impingement, which can lead to undue heating and disturbance forces that can cause dock and component failure. Tether-based docking has the advantage of repeatability and low fuel requirement which is preferred for small satellites. It, however, also poses disadvantages in increased complexity, cost, and weight. Electromagnet-based docking provides a smoother, more accurate docking while having the advantage of not requiring consumables and may be an optimal docking system for small satellites if used in conjunction with thrusters as it cuts down fuel consumption as well as current consumption.

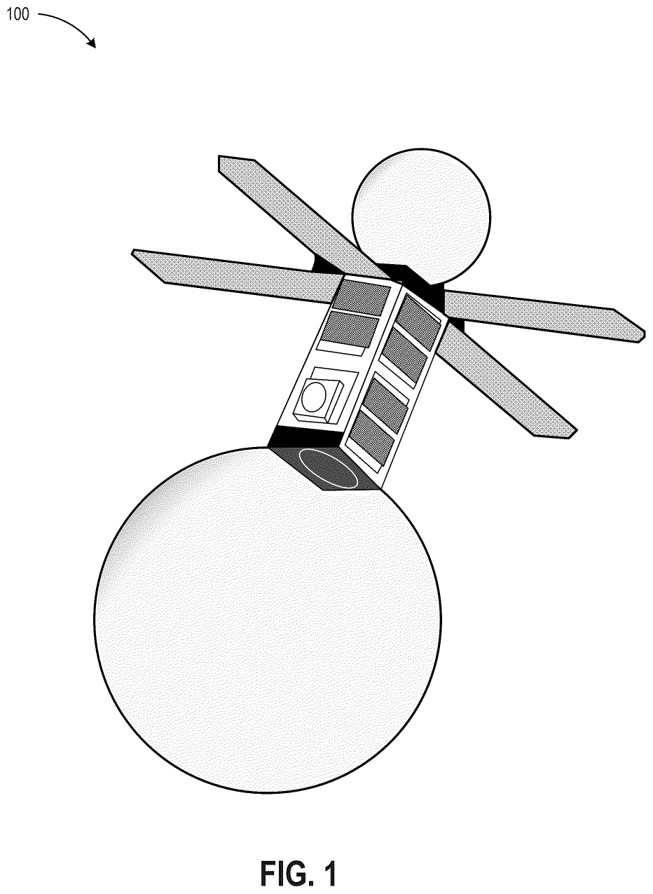

FIG. 1 is an example of a deployed system in operation, consistent with the present disclosure.

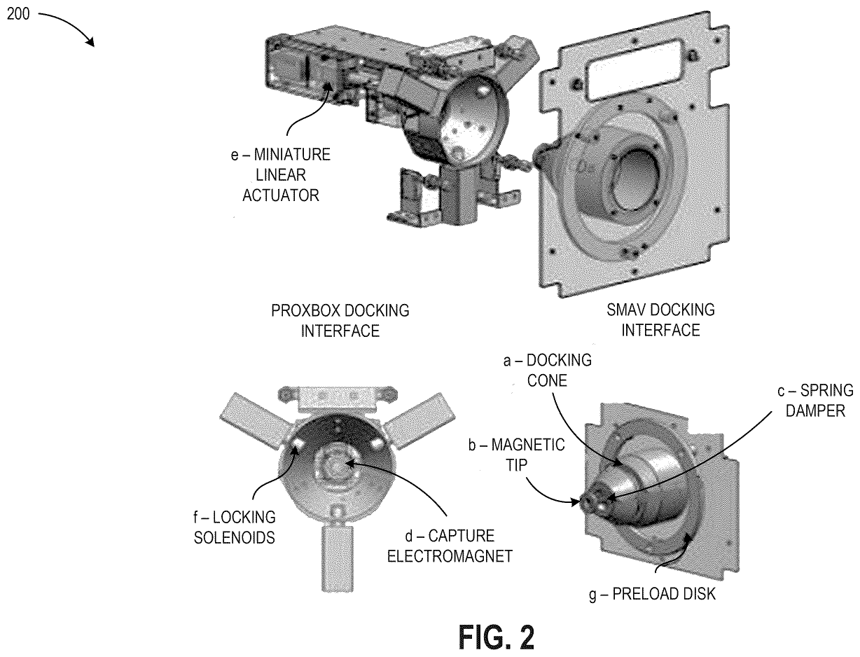

FIG. 2 is an example of a mission docking system, the ARCADE-R2 system, which had an autonomous rendezvous and docking system using permanent magnets. This mission serves as a technology demonstrator mission for permanent magnet based docking. The system used a Continuous Differential GPSS (CDGPS) and on-board Attitude Determination and Control (ADCS) to reduce propellant consumption by thrusters for attitude adjustment and can be used in tandem with any docking system.

Conventional spacecraft docking systems existing onboard the International Space Station (ISS) and other orbiting larger spacecraft utilize complex electromechanical mating and berthing mechanisms to achieve successful mating. The challenge arises when the existing system has to be shrunk down to meet the requirements of small spacecrafts. When shrinking down these systems, the possibility of error goes up as the movements have to be more precise calling for more resolution which in turn, calls for innovation in existing docking technologies to meet the requirements for small satellites.

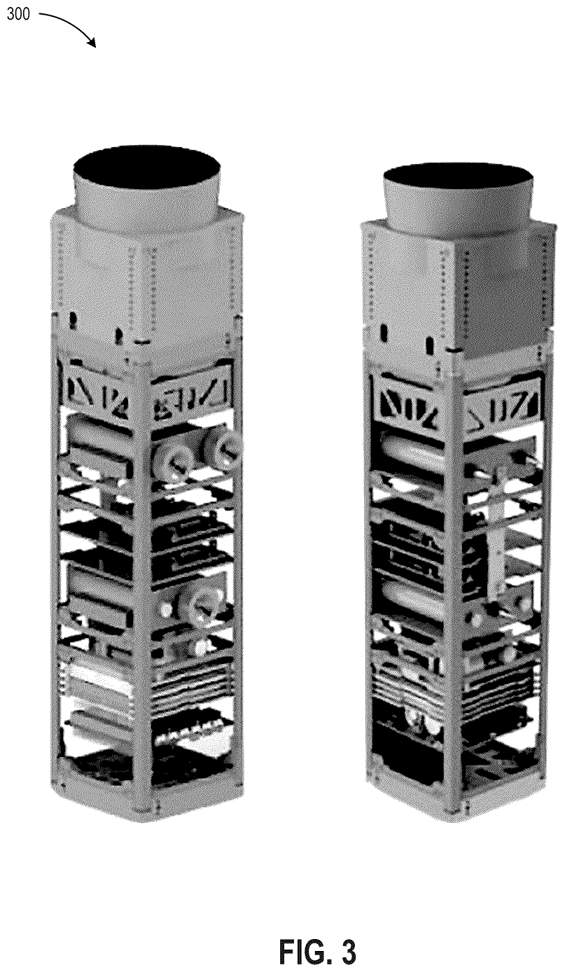

The mating force used in all the design concepts is a magnetic force, usually provided by electromagnets. Most design concepts involve the use of a magnetic force to hold the two docking spacecraft together. One such example is the concept of Autonomous Assembly of Reconfigurable Space Telescope (AAReST) as shown in FIG. 3. The usage of magnets in small satellite systems has a few key disadvantages in causing electromagnetic interference (EMI) with critical measurement systems such as magnetometers and other sensors.

Non-contact docking is a novel approach to handling the docking of small satellites. There have been concepts that have been proposed that can allow small satellites to achieve non-contact docking. An example is the use of the concept of flux-pinning. Flux pinning occurs in certain types of superconductors which, when cooled below their critical temperature in the presence of a magnetic field, resist changes to that initial magnetic flux. A flux-pinned interface exploits this unique behavior by placing a superconductor on one spacecraft module and an array of magnets on another module, thus creating a non-contact connection between them. The present disclosure creates a similar system with the use of electromagnets.

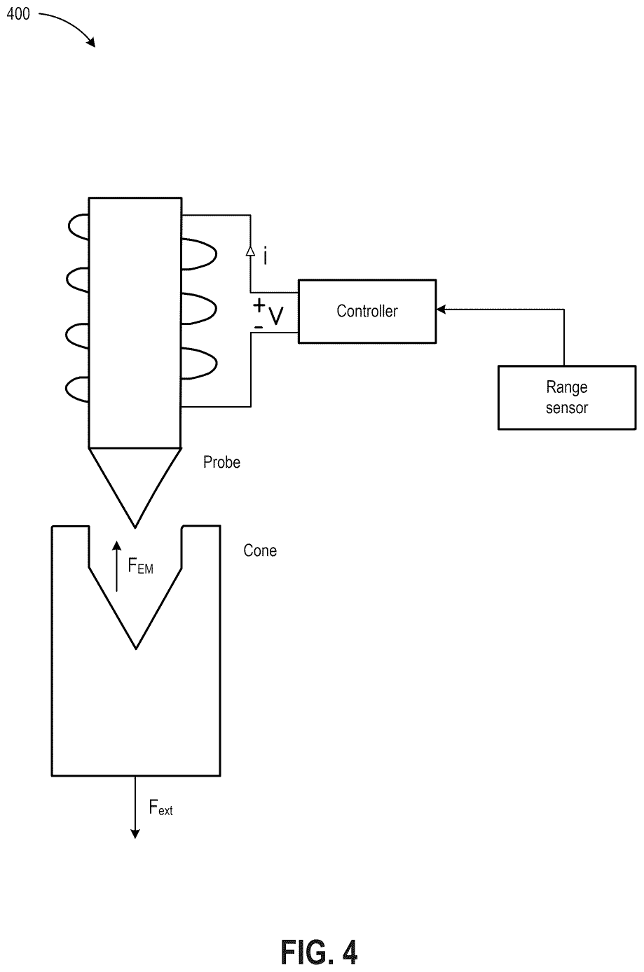

The objective of autonomous electromagnetic non-contact docking is to have the satellites “hover” around each other with the use of concentric electromagnets which will interact actively with the electromagnets on the mating satellite and achieve rotational as well as translational stability. The electromagnets on one spacecraft will interact attractively with the electromagnets on the other spacecraft and attempt to reduce torque using feedback linearization. The control system follows the model of a push and pull levitation mechanism often used in probe and cone mating designs while being adapted for rotational control. FIG. 4 is an example of a probe and cone docking system.

Innovations in CubeSat close proximity technologies have unprecedented advantages to the development of the space economy. For example, enabling the transfer of fuel and electric power between satellites enabled the extension of the lifetime of a critical mission, as demonstrated by Northrop Grumman's Mission Extension Vehicle (MEV), which extended the lifetime of Intelsat 10-02 by five years. While there are several commercial docking technologies available for space missions, the docking technologies available for small satellite operations remain minimal, calling for innovation in development. Development in autonomous non-contact docking technology could have serious implications in applications of small satellites like formation flying, surveillance, security, and fault detection.

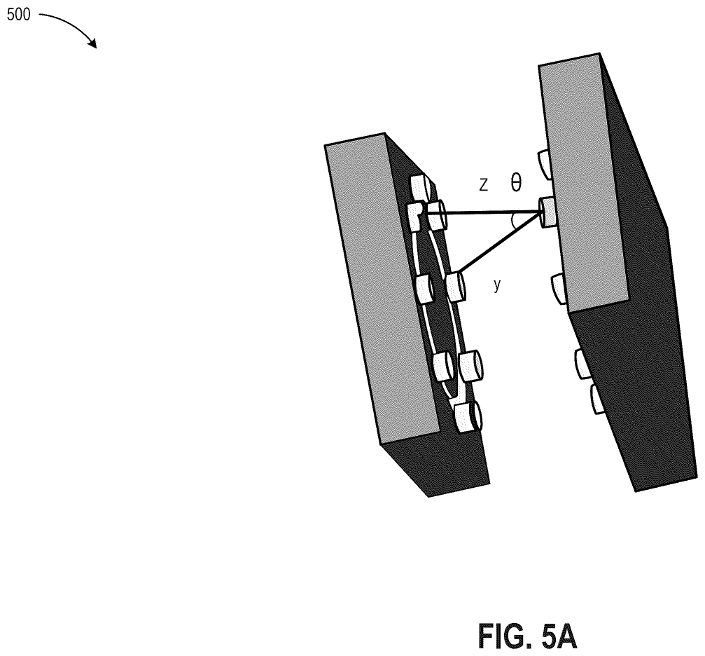

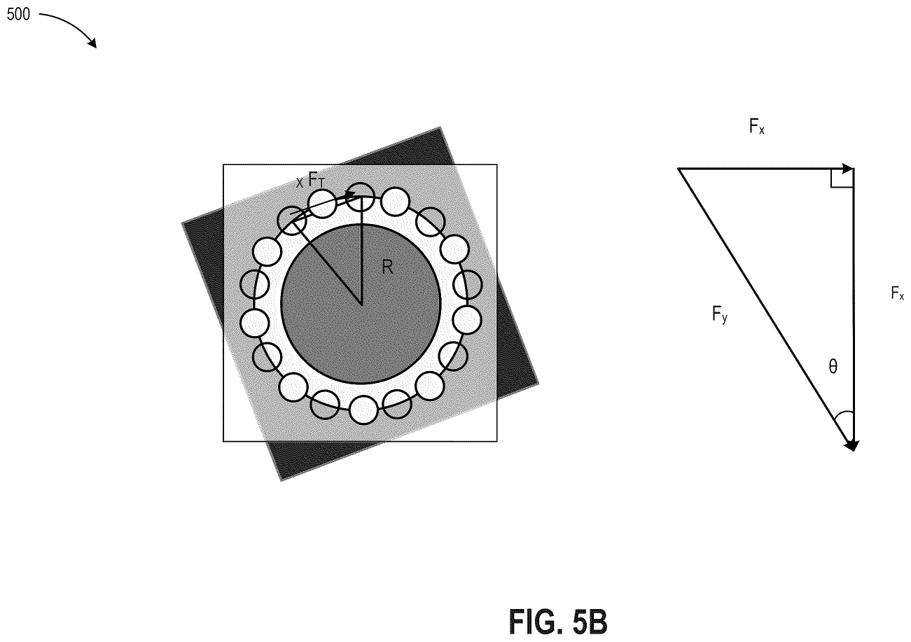

FIG. 5 is an example of a dynamic model of an electromagnetic system, consistent with the present disclosure. The docking system is responsible for attitude adjustment in 2 degrees of freedom (DOF). The system may first attempt to match the external torque of a runner CubeSat and achieve a zero relative torque while being held stationary along z by using the inflatable system as shown in FIG. 1. This may be done by matching the force generated by the change in pressure with the net axial force of the CubeSat which will be given by Equation (1) for the duration of the attitude adjustment.

$${F}_{net} = {F}_{ext} - {F}_{z} \qquad ( 1 )$$

The repulsive force of the magnet results in Fₙₑₜ which is countered equally by the inflatable system. Once the rotational adjustment is complete, the system may then attempt to control axial translation along z. Disclosed herein is the control of electromagnets for the rotational and translational attitude adjustment.

For the rotational attitude adjustment, the system dynamics has been modeled based on FIG. 5. The system is taken as two identical mating adapters with the change in orientation between the centers of the magnets in the initial and desired position being taken as θ which is initially an angle where sin θ is much greater than cos θ. The tangential force is greater than the axial force initially. Eventually the axial force would be the only existing force as cos θ approaches 1. The system works in tandem with an inflatable system which attempts to negate the axial forces during the rotational attitude adjustment so that the CubeSat can be aligned before the system translationally docks along the z-axis. In the disclosed model, only F_{T}, the tangential force, is used to calculate the torque required to be generated by each electromagnet to twist the CubeSat about the z-axis.

Described herein are the dynamics of using one pair of electromagnets that are filamentary circular coils and then the equations are generalized for the system. Due to symmetry of the CubeSats and coplanarity about the axis, the net moment produced on the system during the operation is zero and the only acting forces are axial and tangential. The electromagnetic docking system is modeled using first principles as in Equation 1 through Equation 7. Here, iᵣ(t) and i_{z}(t) are current flowing through the circuit for the rotational system and translational system respectively, u(t) is the voltage input, R is the resistance of the electromagnetic circuit, N is the number of turns of the electromagnetic coil, L_{I} is the self-inductance of the electromagnetic coil, r and h are the radius and height of one coil, L(y) is the mutual inductance of the electromagnet pair system, which is a function of y, the distance between them, Rl, is the reluctance of the electromagnetic circuit, μ₀ is the permeability of free space, m is the mass of the satellite, r_{c} is the radius of the circular disc around which the coils are placed circumferentially, and Fₑₓₜ is the external force, either gravitational or other forces. The mutual inductance L(y) is modeled between the two coils as given below in Equation (2).

$$L ( y ) = \frac{{μ}_{0} {N}^{2} π ( {r}^{2} )}{y} \qquad ( 2 )$$

$$\frac{{di}_{\text{?}}}{di} = \frac{1}{{L}_{1}} u ( t ) - \frac{R}{{L}_{1}} {i}_{r} \qquad ( 3 )$$

$${F}_{y} ( y , i ) = \frac{- d}{dy} ( \frac{1}{2} L ( y ) {{i}_{r}}^{2} ( t ) ) \qquad ( 4 )$$

$${F}_{y} ( y , i ) = \frac{{μ}_{0} {N}^{2} π ( {r}^{2} )}{2 {y}^{2}} {{i}_{r}}^{2} \qquad ( 5 )$$

$${F}_{y} ( y , i ) = k \frac{{{i}_{r}}^{2}}{{y}^{2}} \qquad ( 6 )$$

$${F}_{T} ( y , i ) = {F}_{y} ( y , i ) sin θ \qquad ( 7 )$$

$$τ ( y , i ) = {F}_{y} ( y , i ) sin θ {r}_{c} \qquad ( 8 )$$

$$τ ( y , i ) = k \frac{{{i}_{r}}^{2}}{{y}^{2}} sin θ {r}_{c} \qquad ( 9 )$$

$$y = \frac{z}{cos θ} \qquad ( 10 )$$

$$τ ( θ , i ) = k \frac{{{i}_{r}}^{2}}{{\text{?}}^{2}} sin θ {cos}^{2} θ {r}_{c} \qquad ( 11 )$$

$$\text{?} \text{indicates text missing or illegible when filed}$$

Here z is constant as the CubeSat is not moving axially as per the initial conditions. This allows z to be isolated as a constant and results in the torque produced by the system as Equation (12) resulting in Equation (13) from Newton's second law.

$$r ( θ , i ) = {k}^{′} {{i}_{r}}^{2} sin θ {cos}^{2} θ {r}_{c} \qquad ( 12 )$$

$$\frac{{d}^{2} θ}{{dt}^{2}} = - \frac{{k}^{′}}{\text{?}} {{i}_{r}}^{2} sin θ {cos}^{2} θ {r}_{c} + \frac{{r}_{ext}}{\text{?}} \qquad ( 13 )$$

$$\text{?} \text{indicates text missing or illegible when filed}$$

The system can be represented in state space model as in Equations (14) through (17). Here x1=θ, x2=θ, x3=i(t), and θ as the output of the system.

$${\dot{x}}_{1} = {x}_{2} \qquad ( 14 )$$

$${\dot{x}}_{2} = - \frac{{k}^{′}}{\text{?}} {{x}_{3}}^{2} sin {x}_{1} {cos}^{2} {x}_{1} {r}_{c} + \frac{{r}_{ext}}{\text{?}} \qquad ( 15 )$$

$${\dot{x}}_{3} = \frac{1}{\text{?}} u ( t ) - \frac{R}{\text{?}} {x}_{3} \qquad ( 16 )$$

$$θ = {x}_{1} \qquad ( 17 )$$

$$\text{?} \text{indicates text missing or illegible when filed}$$

This system is of the form shown in Equations (18) and (19) below.

$$\dot{x} = f ( x ) + g ( x ) u \qquad ( 18 )$$

$$y = h ( x ) \qquad ( 19 )$$

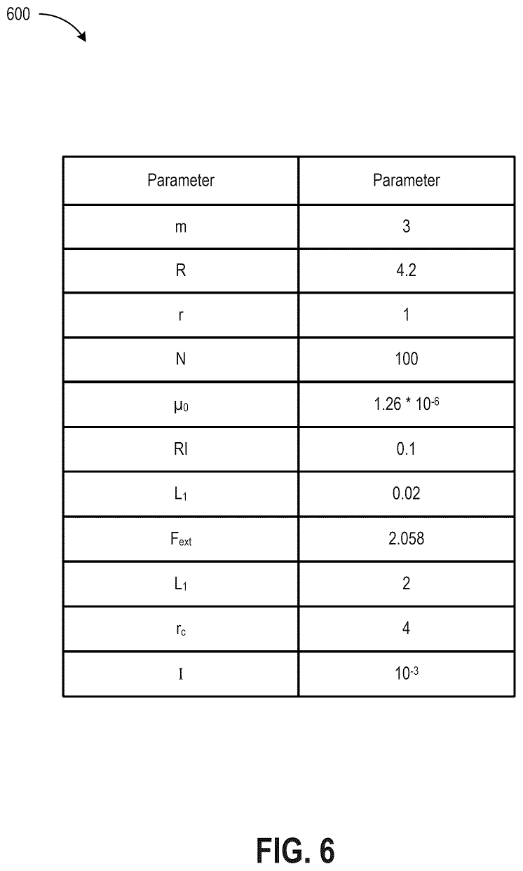

FIG. 6 is an example of system parameters for the example electromagnetic system of FIG. 5, where the values of the parameters are summarized in the table. In order to control the dynamics of the system using linear control, the system has to be linear. However, the electromagnetic attitude adjustment system which is the plant has non-linear dynamics and thus the system has to be linearized first.

After the rotational attitude adjustment, the CubeSat will then need to be translationally controlled along the z-axis to the required distance d away from each other. The inflatable system will have reduced the external force to 0 but then a new external force will be subjected to the system when the inflatable is decommissioned. For this situation, the system implements a translational control system similar system to the rotational attitude adjustment. The dynamics of this system are given by Equations (20) through (24).

$$L ( z ) = \frac{{μ}_{0} {N}^{2} π ( {r}^{2} )}{z} \qquad ( 20 )$$

$$\frac{{di}_{z}}{dt} = \frac{1}{{L}_{\text{?}}} u ( t ) - \frac{R}{{L}_{\text{?}}} {i}_{z} \qquad ( 21 )$$

$${F}_{z} ( z , i ) = \frac{- d}{dy} ( \frac{1}{2} L ( z ) {{i}_{z}}^{2} ( t ) ) \qquad ( 22 )$$

$${F}_{z} ( y , i ) = \frac{{μ}_{0} {N}^{2} π ( {r}^{2} )}{2 \text{?}} {{i}^{2}}_{z} \qquad ( 23 )$$

$${F}_{z} ( y , i ) = k \frac{{{i}^{2}}_{z}}{\text{?}} \qquad ( 24 )$$

$$\text{?} \text{indicates text missing or illegible when filed}$$

Newton's second law yields Equation (25).

$$\frac{{{d}^{2}}_{z}}{{dt}^{2}} = - \frac{k}{m} \frac{{{i}_{z}}^{2}}{{z}^{2}} + \frac{{F}_{ext}}{m} \qquad ( 25 )$$

The system may be represented in a state space model as in Equations (26) through (29). Here x1=z, x2=, x3=i(t), and z as the output of the system.

$${\dot{x}}_{1} = {x}_{2} \qquad ( 26 )$$

$${\dot{x}}_{2} = - \frac{k}{m} \frac{z \text{?}}{z \text{?}} + \frac{{F}_{ext}}{m} \qquad ( 27 )$$

$${\dot{x}}_{3} = \frac{1}{{L}_{\text{?}}} u ( t ) - \frac{R}{{L}_{\text{?}}} {x}_{3} \qquad ( 28 )$$

$$z = {x}_{1} \qquad ( 29 )$$

$$\text{?} \text{indicates text missing or illegible when filed}$$

This state space model follows the same form as (18) and (19) and thus needs to be linearized before it may be used to apply linear control to the dynamics of the system.

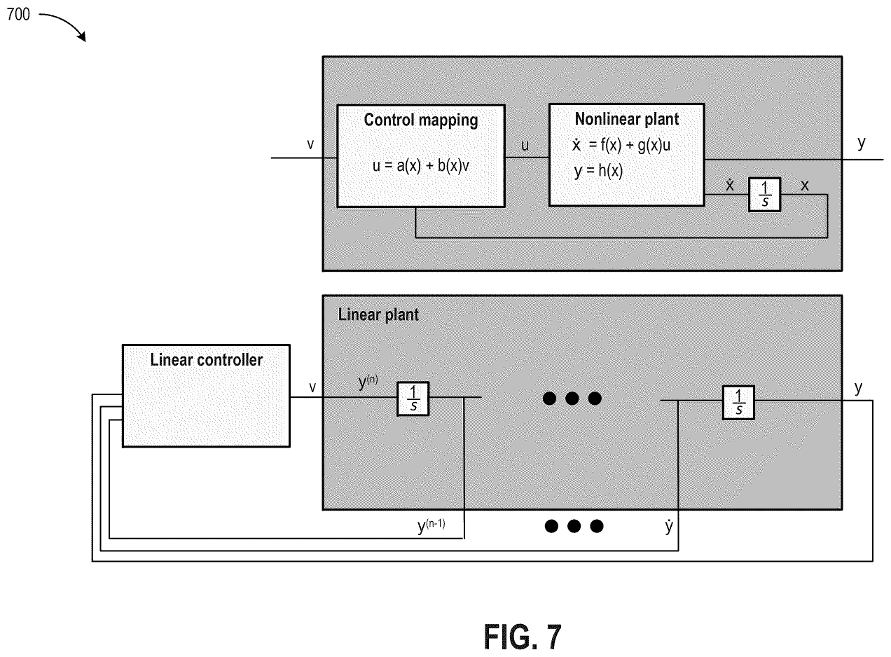

The purpose of feedback linearization is to model the system in a way that linearizes the system and allows application of linear control to the dynamics of the system. The approach involves transforming a nonlinear control system into an equivalent linear control system through a change of variables and a suitable control input. A change of coordinates would then create a new equation in terms of a new input z(t) and output x(t) that results in a linear system. FIG. 7 is an example block diagram of a feedback linearization model, consistent with the present disclosure.

A simple way of implementing feedback linearization in the system may be achieved by a controller that converts the system into a classic second-order system of the form shown in Equation (30).

$$m \ddot{x} + c \dot{x} + kx = constant \qquad ( 30 )$$

Using this concept, controllers may be designed for both the rotational attitude adjustment and translational control system. By taking the non-linear terms from Equations (15) and (25) and equating them to the linear terms in Equation (30), a controller may be incorporated to stabilize the system at the intended time period.

$${c}_{1} \dot{θ} + {k}_{1} θ = - \frac{{mk}^{′}}{i} {i}^{2} sin {θcos}^{2} θ {r}_{c} \qquad ( 31 )$$

$${{i}_{r}}^{2} = v = \dot{k} \frac{c \dot{θ} + k θ}{sin {θcos}^{2} θ {r}_{c}} \qquad ( 32 )$$

Equation (32) yields a controller that takes in angle θ and the angular velocity as inputs to output current which can then be used for now linearized system of the form Equation (31). A similar approach can also be applied for the translational control.

$${c}_{2} \dot{z} + {k}_{2} z = - mk \frac{{i}^{2}}{{z}^{2}} \qquad ( 33 )$$

$${{i}_{z}}^{2} = w = \frac{- {z}^{2} ( {c}_{2} \dot{z} + {k}_{2} z )}{mk} \qquad ( 34 )$$

Equation (34) yields a controller that takes in the linear translation z and velocity as input to give current i. The system response is a typical second-order system response due to the linearization technique applied that should result in a classical second-order system equation of the form in Equation (30). The values of c and k can be decided from the expected time for docking and expected settling time.

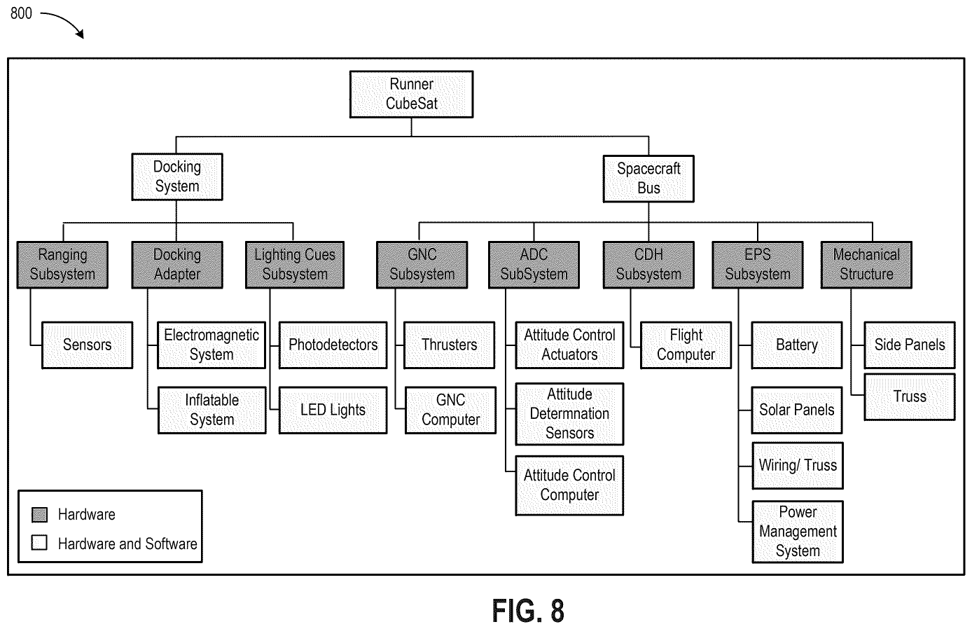

FIG. 8 is an example functional block diagram for a non-contact docking CubeSat, consistent with the present disclosure. Disclosed is a 3U CubeSat with a 1U Docking Adapter, 1U Bus, and the remaining space used for payload and instruments as a technology demonstration. To optimize the satellite's heritage and reduce the danger of failure, COTS (Commercial-Off-The-Shelf) parts are used for all other components. The system modeling and some of the top-level requirements in the previous sections.

In one example of the system in operation, the two docking CubeSats, called the “Runner” and the “Chaser,” or target, are launched in Low Earth Orbit (LEO). Both of them turn on, their solar panels unfurl, and they perform their initial checks to see if all systems are functional. This phase is called deployment. Both of the CubeSats have spacecraft indicator lights, typically LEDs, on their outer surface for target identification, analogous to airplanes use blinking lights to convey messages in the air.

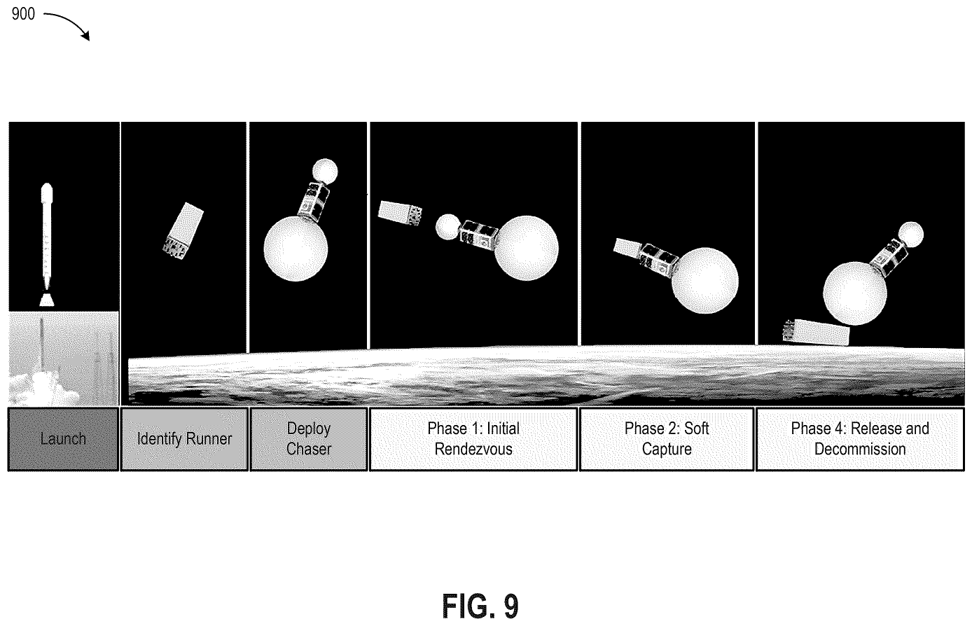

Initially, the runner and the chaser start blinking the indicator lights at a predetermined rate. When a spacecraft detects the other spacecraft, the identification phase is complete. Once the target identification is complete, the lights start blinking faster. The system then uses CubeSat propulsion to move the runner CubeSat and chaser CubeSat closer together. The blinking becomes faster as they approach closer. Once the rate that the indicator lights are blinking reaches a predetermined rate, the spacecraft determine that they are sufficiently close together, and both the runner and the chaser turn off their indicator lights, and the two CubeSats join together in a two-step process. The first step involves the deployment of the inflated balloon structure by using a compressed gas canister on board. In the second step the electromagnets are turned on and are used for attitude adjustment to enable close proximity operations. After the proximity operations are successfully performed, the electromagnetic systems are turned off, and the two CubeSats are decommissioned and then burn up in the Earth's atmosphere, this process is pictorially depicted in the ConOps diagram (FIG. 9).

The system may be expected to behave the same way as a classical second order system of the form in Equation (35).

$$\ddot{x} + \frac{c}{m} \dot{x} + \frac{k}{m} x = constant \qquad ( 35 )$$

This can be modeled as a system with the second-order transfer function with ζ and ω which results in a the transfer function G[s] as shown in Equation (36).

$$G [ s ] = \frac{\frac{1}{m}}{{s}^{2} + \frac{c}{m} s + \frac{k}{m}} \qquad ( 36 )$$

This equation can also be represented as Equation (37).

$$G [ s ] = \frac{\frac{1}{m}}{{s}^{2} + 2 ζω s + {ω}^{2}} \qquad ( 37 )$$

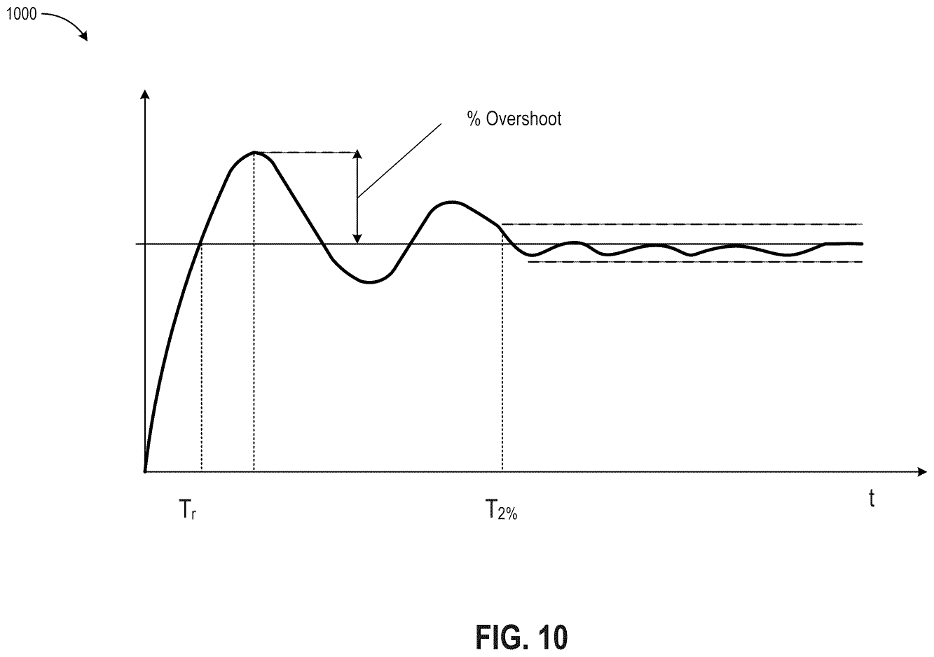

Here ζ is the damping ratio of the system and ω is the undamped natural frequency of the system. By choosing the values of c and k for the controller, the damping ratio and the natural frequency of the system is determined as per the requirements. The rise time, 1% settling time, and 2% settling time for the system is given by Equations (38), (39), and (40). FIG. 10 is an example of a step response of a second-order system, consistent with the present disclosure.

$${T}_{r} = \frac{1.8}{ω} \qquad ( 38 )$$

$${T}_{1 \%} = \frac{4.6}{ζω} \qquad ( 39 )$$

$${T}_{2 \%} = \frac{4}{ζω} \qquad ( 40 )$$

The values of c and k will influence the time period of the system and therefore, the controller can be tuned to find the best values of the coefficients c and k for each system. The feedback linearized system may be expected to reduce the net relative torque about the z-axis for the CubeSat to 0 within the settling time and translationally reduce z to a distance d.

The system may be linearized through Taylor linearization techniques and may be used with a proportional-integral-derivative (PID) controller or a Linear Quadratic Gaussian (LQG) controller. A more holistic feedback linearization technique involving lie derivatives may be used for a more optimal controller which may then be used in combination with a Kalman filter for a steadier system response.

Docking systems enable on-orbit servicing, in-space assembly, and repair of large space structures. Building small satellite docking systems enables small satellites to interact with each other as well as other large satellites, enabling resource sharing including power, data, and fuel. Several autonomous docking systems exist for space systems, but they are still lacking when it comes to CubeSats. The existing designs for CubeSat docking systems have disadvantages in certain applications like formation flying and surveying which calls for innovation in CubeSat technologies, especially to enable close-proximity operations. With the development of the attitude adjustment system using electromagnets as disclosed herein, it is possible to replace bulky sensors, cameras, etc., and have a higher success rate and precision in docking as well as use small satellites for more applications that require novel technologies. This disclosure covers a system that helps achieve control over two DOF of a CubeSat with the use of sequential control of electromagnets, which aids in the initial rendezvous of the two docking spacecraft.

According to one aspect of the disclosure there is thus provided a system for autonomously docking a spacecraft, the system comprising: one or more electromagnets; one or more sensors; and a controller. The controller configured to: identify a target; cause movement of the spacecraft closer to the target; determine a change in an orientation of the one or more electromagnets and the mating adapter on the target; and adjust a current in the one or more electromagnets to produce a torque, wherein the torque causes the spacecraft to align with the target.

According to another aspect of the disclosure, there is provided a system for autonomously docking a spacecraft, the system comprising: one or more electromagnets; one or more sensors; an inflatable device; one or more thrusters; and a controller. The controller is configured to: identify a target; cause movement of the spacecraft closer to the target; responsive to determining that the spacecraft is sufficiently close to the target, deploy the inflatable device; perform attitude adjustment and close proximity operations using the one or more electromagnets; and join the spacecraft to the target.

According to yet another aspect of the disclosure, there is provided a system for autonomously docking a spacecraft, the system comprising: one or more electromagnets; one or more sensors; and a controller. The controller is configured to: identify a target; cause movement of the spacecraft closer to the target; determine that the spacecraft is sufficiently close to the target; perform attitude adjustment and close proximity operations using the one or more electromagnets; and join the spacecraft to the target.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry,” as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

Embodiments of the methods described herein may be implemented using a controller, processor and/or other programmable device. To that end, the methods described herein may be implemented on a tangible, non-transitory computer readable medium having instructions stored thereon that when executed by one or more processors perform the methods.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto.

It will be appreciated by those skilled in the art that any block diagrams herein represent conceptual views of illustrative circuitry embodying the principles of the disclosure. Similarly, it will be appreciated that any block diagrams, flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

The functions of the various elements shown in the figures, including any functional blocks labeled as a controller or processor, may be provided through the use of dedicated hardware as well as hardware capable of executing software in association with appropriate software. The functions may be provided by a single dedicated processor, by a single shared processor, or by a plurality of individual processors, some of which may be shared. Moreover, explicit use of the term controller or processor should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

The term “coupled” as used herein refers to any connection, coupling, link or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art.

What is claimed is:

1. A system for autonomously docking a spacecraft, the system comprising:
one or more electromagnets;
one or more sensors;
an inflatable device;
one or more thrusters; and
a controller, the controller configured to:
identify a target;
cause movement of the spacecraft closer to the target;
responsive to determining that the spacecraft is sufficiently close to the target, deploy the inflatable device;
perform attitude adjustment and close proximity operations using the one or more electromagnets; and
join the spacecraft to the target;
a plurality of spacecraft indicator lights; and
one or more photodetectors;
wherein identify the target further comprises:
blinking the plurality of spacecraft indicator lights on the spacecraft; and
responsive to detecting the blinking of a plurality of target indicator lights by the one or more photodetectors, increase a rate that the plurality of spacecraft indicator lights are blinking to signal that the target is detected.

2. The system of claim 1, wherein deploy the inflatable device comprises:
deploy a balloon structure using a compressed gas canister on board the spacecraft.

3. (canceled)

4. (canceled)

5. The system of claim 1, wherein move the spacecraft closer to the target comprises:
responsive to the rate that the plurality of target indicator lights are blinking, move the spacecraft closer to the target; and
responsive to the rate that the plurality of target indicator lights are blinking reaching a predetermined rate, turn off the plurality of spacecraft indicator lights on the spacecraft.

6. The system of claim 1, wherein the system performs an attitude adjustment in 2 degrees of freedom.

7. The system of claim 1, wherein the one or more electromagnets are identical to a mating adapter on the target.

8. The system of claim 7, wherein perform the attitude adjustment and the close proximity operations using the one or more electromagnets further comprises:
determine a change in an orientation of the one or more electromagnets and the mating adapter on the target; and
adjust a current in the one or more electromagnets to produce a torque, wherein the torque causes the spacecraft to align with the target.

9. A system for autonomously docking a spacecraft, the system comprising:
one or more electromagnets;
one or more sensors; and
a controller, the controller configured to:
identify a target;
cause movement of the spacecraft closer to the target;
determine that the spacecraft is sufficiently close to the target,
perform attitude adjustment and close proximity operations using the one or more electromagnets; and
join the spacecraft to the target;
a plurality of spacecraft indicator lights; and
one or more photodetectors;
wherein identify the target further comprises:
blinking the plurality of spacecraft indicator lights on the spacecraft; and
responsive to detecting the blinking of a plurality of target indicator lights by the one or more photodetectors, increase a rate that the plurality of spacecraft indicator lights are blinking to signal that the target is detected.

10. The system of claim 9, further comprising an inflatable device; and wherein the controller to deploy the inflatable device when the spacecraft is sufficiently close to the target; and wherein the inflatable device comprises a balloon structure and a compressed gas canister to inflate the balloon.

11. (canceled)

12. (canceled)

13. The system of claim 9, wherein move the spacecraft closer to the target comprises:
responsive to the rate that the plurality of target indicator lights are blinking, move the spacecraft closer to the target; and
responsive to the rate that the plurality of target indicator lights are blinking reaching a predetermined rate, turn off the plurality of spacecraft indicator lights on the spacecraft.

14. The system of claim 9, wherein the system performs an attitude adjustment in 2 degrees of freedom.

15. The system of claim 9, wherein the one or more electromagnets are identical to a mating adapter on the target.

16. The system of claim 9, wherein perform the attitude adjustment and the close proximity operations using the one or more electromagnets further comprises:
determine a change in an orientation of the one or more electromagnets and the mating adapter on the target; and
adjust a current in the one or more electromagnets to produce a torque, wherein the torque causes the spacecraft to align with the target.

17. A system for autonomously docking a spacecraft, the system comprising:
one or more electromagnets;
one or more sensors; and
a controller, the controller configured to:
identify a target;
cause movement of the spacecraft closer to the target;
determine a change in an orientation of the one or more electromagnets and the mating adapter on the target; and
adjust a current in the one or more electromagnets to produce a torque, wherein the torque causes the spacecraft to align with the target;
wherein identify the target further comprises:
blinking a plurality of spacecraft indicator lights on the spacecraft; and
responsive to detecting the blinking of a plurality of target indicator lights by one or more photodetectors, increase a rate that the plurality of spacecraft indicator lights are blinking to signal that the target is detected; and
wherein move the spacecraft closer to the target comprises:
responsive to the rate that the plurality of target indicator lights are blinking, move the spacecraft closer to the target; and
responsive to the rate that the plurality of target indicator lights are blinking reaching a predetermined rate, turn off the plurality of spacecraft indicator lights on the spacecraft.

18. The system of claim 17, further comprising an inflatable device; and wherein the controller to deploy the inflatable device when the spacecraft is sufficiently close to the target; and wherein the inflatable device comprises a balloon structure and a compressed gas canister to inflate the balloon.

19. (canceled)

20. (canceled)
